(19) United States
(12) Patent Application Publication
(10) Pub. No.: US 2005/0030598 A1
(43) Pub. Date: Feb. 10, 2005

(54) SCANNER WITH SCANNING MODULE LOCATION AUXILIARY

(76) Inventor: MING-KUAN QIAN, Tai-Chou City (CN)

Correspondence Address: (NAIPC) NORTH AMERICA INTERNATIONAL PATENT OFFICE, P.O. BOX 506, MERRIFIELD, VA, 22116, US

(21) Appl. No.: 10/710,837

(22) Filed: Aug. 5, 2004

(30) Foreign Application Priority Data
Aug. 7, 2003 (TW) 092121718

(51) Int. Cl. H04N 1/04

(52) U.S. Cl. 358/497; 358/506

(57) ABSTRACT

A scanner includes a housing, a transparent platform installed on the housing, a shaft installed inside the housing, and a scanning module installed inside the housing and on the shaft in a movable manner. The scanning module comprises a sensing module for scanning a document on the transparent platform and transforming it into digital signal and a sensor carriage. The sensor carriage comprises a base for carrying the sensing module, and a buffer pad connected to the base in a rotatable manner for contacting the transparent platform and fixing the sensing module in the sensor carriage.

### BACKGROUND OF INVENTION

1. Field of the Invention

The present invention relates to a scanner, and more specifically, to a scanner with scanning module location auxiliary.

2. Description of the Prior Art

Over the last decade, the development of computer peripherals and other electronic apparatus has progressed almost daily. These devices are now utilized universally in daily life. Take the scanner as an example. A scanner is a very popular electronic apparatus for scanning a document and generating corresponding data, or for converting image data, such as photographs, into a digital format that can be operated on and modified with a computer. In addition, the scanner may provide some additional functions such as facsimileing image data through a telephone line, sending image data by e-mail through the Internet, copying image data as a copy machine, or even posting converted image data on the Internet.

Please refer to FIG. 1 showing an external view of a conventional scanner 10. The scanner 10 includes a housing 12, a transparent platform 14, a track 16, a light source 20, and a scanning module 18. The transparent platform 14 is installed on the housing 12 for placing a document, and the scanning module 18 is installed on the track 16 and can move in either direction along the X-axis for scanning the document to generate corresponding image signals. When the scanner 10 scans, the scanning module 18 moves along the track 16 to scan the document, and when the scanning is finished, the scanning module 18 moves back to a specific point A and the scanner 10 enters an idle mode.

As described above, the image-sensing component of the scanning module 18 can be such devices as a contact image sensor (CIS) or a charge coupled device (CCD). The image-sensing component is a main device of the scanner 10 and is a light-receptor for converting the receiving image into digital format. However generally the depth of the field of the CIS is small so that the CIS can not be too far from the document and has to be at a certain distance from the transparent platform 14 and scanning back and forward to achieve the good scanning quality. Thus there is a need to make the location of the scanning module 18 precise and closer to the transparent platform 14 for scanning the document clearly.

### SUMMARY OF INVENTION

It is therefore a primary objective of the present invention to provide a scanner with a scanning module location auxiliary to solve the problem mentioned above.

Briefly summarized, a scanner includes a housing, a transparent platform installed on the housing, a shaft installed inside the housing, and a scanning module installed inside the housing and on the shaft in a movable manner. The scanning module comprises a sensing module for scanning a document on the transparent platform and transforming it into a digital signal. A sensor carriage comprising a base for carrying the sensing module, and a buffer pad connected to the base in a rotatable manner for contacting the transparent platform and fixing the sensing module in the sensor carriage.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an external view of a conventional scanner.

FIG. 2 is a drawing of a scanner according to the present invention.

FIG. 3 is a drawing of the scanning module of FIG. 2.

FIG. 4 is an enlarged drawing of the joint of a buffer pad and a base of FIG. 3.

FIG. 5 and FIG. 6 are diagrams illustrating the combination of the buffer pad and a sensing module.

FIG. 7 is a diagram illustrating the scanning module close to a transparent platform.

FIG. 8 is a diagram illustrating the scanning module installed on a shaft.

FIG. 9 is an enlarged drawing of the joint of a buffer component and the shaft.

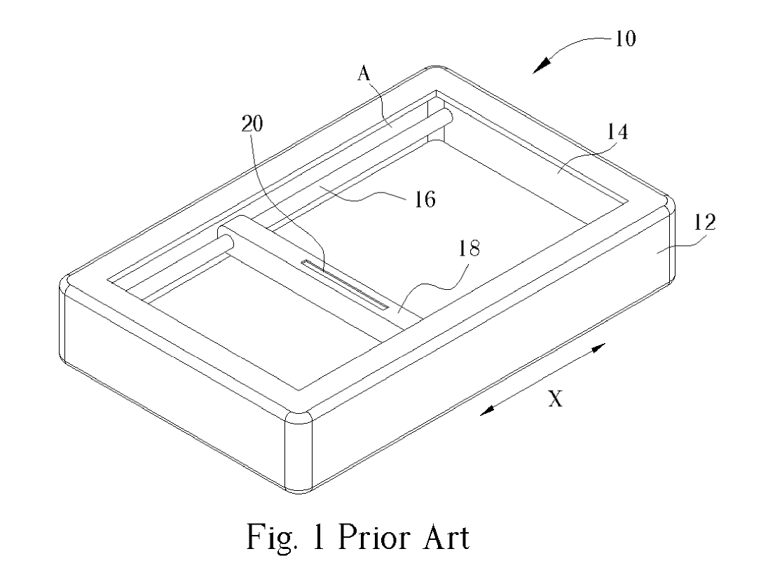

### DETAILED DESCRIPTION

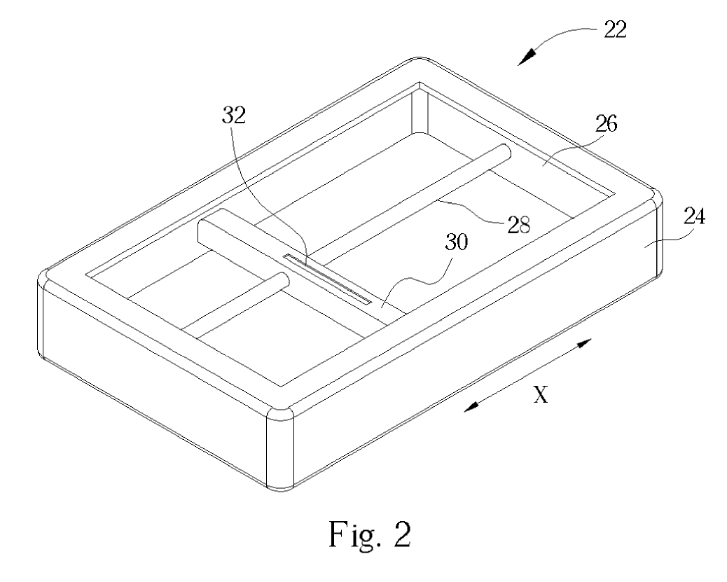

Please refer to FIG. 2. FIG. 2 is a drawing of a scanner 22 according to the present invention. The scanner 22 includes a housing 24, a transparent platform 26 installed on the housing 24, a shaft 28 installed inside the housing, and a scanning module 30 installed inside the housing 24 and on the shaft 28 in a movable manner. A document is laid on the transparent platform 26 to be scanned and the scanning module 30 slides along the X-direction for scanning the document. The scanning module 30 includes a light source 32 for providing the scanning light. The scanning module receives the scanning light reflected from the document to generate an image signal of the document.

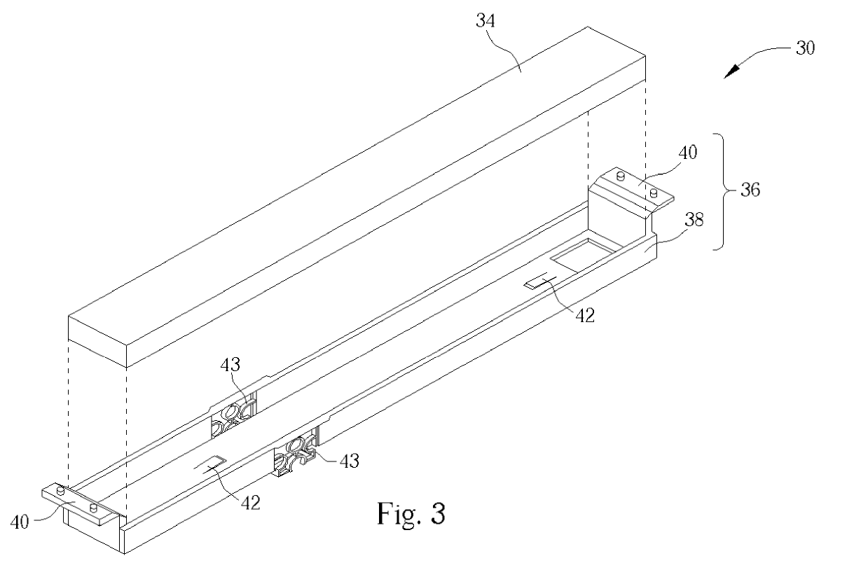

Please refer to FIG. 3. FIG. 3 is a drawing of the scanning module 30. The scanning module includes a sensing module 34 for scanning a document on the transparent platform 26 and transforming it into a digital signal. The sensing module 34 can include a contact image sensor (CIS), a plurality of charge coupled devices, or a plurality of complementary metal-oxide semiconductors (CMOS). The scanning module 36 further includes a sensor carriage 36 having a base 38 for carrying the sensing module 34, two buffer pads 40 connected to the base 38 in a rotatable manner for contacting the transparent platform 26 and fixing the sensing module 34 in the sensor carriage 36, and two elastic components 42 installed on the bottom of the base 38 for supporting the sensing module 34 vertically. The elastic component 42 can be a fragment or a spring. The scanner 22 further includes two buffer components 43 installed under the scanning module 30 and connected to the shaft 28 in a movable manner for supporting the scanning module 30 elastically and ensuring the scanning module 30 is close to the transparent platform 26. The buffer component 43 can be a spring mechanism.

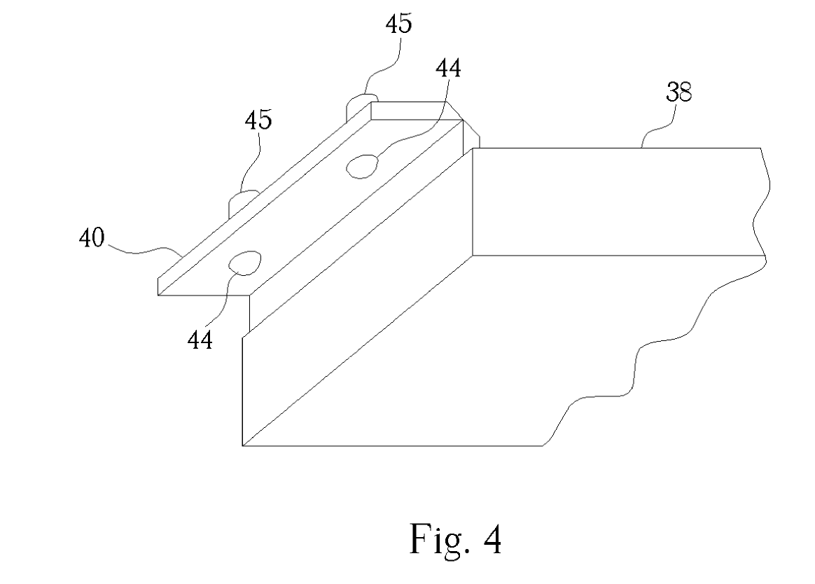

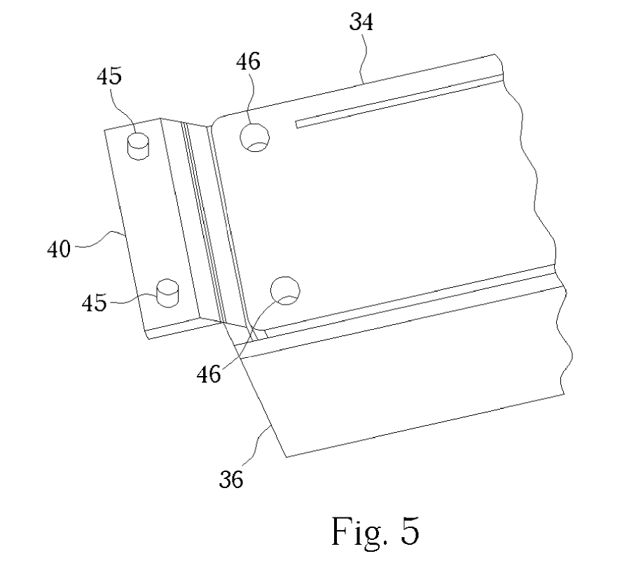

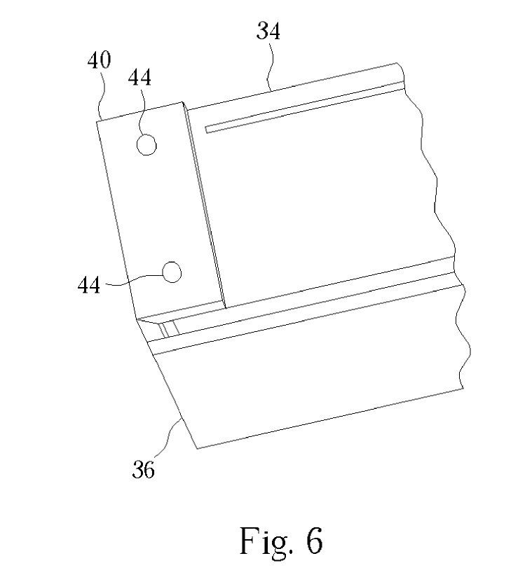

Please refer to FIG. 4. FIG. 4 is an enlarged drawing of the joint of the buffer pad 40 and the base 38. Each of the two buffer pads 40 includes two bolts 45 and two wearing spacers 44 installed on the plane opposite to the bolts 45 for contacting the transparent platform 26. The wearing spacers 44 are flanges of wearing-resisting material. Please refer to FIG. 5 and FIG. 6. FIG. 5 and FIG. 6 are diagrams illustrating the combination of the buffer pad 40 and the sensing module 34. In FIG. 5, the sensing module 34 is placed in the sensor carriage 36 and there are two holes 46 installed on the one end of the sensing module 34 and facing to the two bolts 45 on the buffer pad 40. Please refer to FIG. 6. When the sensing module 34 is fixed in the senor carriage 36 by the buffer pad 40, the two bolts 45 are inserted into the two holes 46 by rotating the buffer pad 40. In this way, the sensing module 34 is positioned in the sensor carriage 36 more precisely. However, the method of fixing the sensing module 34 in the sensor carriage 36 by the buffer pad 40 can also be of another type of mechanism.

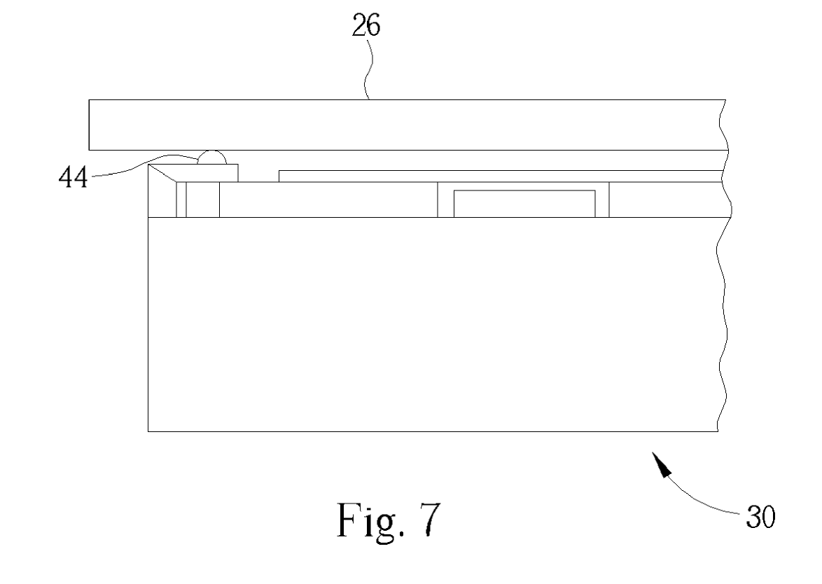

Please refer to FIG. 7. FIG. 7 is a diagram illustrating the proximity of the scanning module 30 and the transparent platform 26. The scanning module 30 contacts the transparent platform 26 through the wearing spacers on the buffer pad 40. This causes the scanning module 30 to contact with the transparent platform 26 closely when the scanning module 30 moves on the shaft 28 forward and backward. The distance between the scanning module 30 and the document on the transparent platform 26 is thereby held steady and precision positioning is achieved.

When the sensing module 34 is located in the sensor carriage 36, the elastic component 42 installed on the bottom of the base 38 supports the sensing module 34 vertically. The elastic component 42 elastically ensures that the scanning module 34 is close to the buffer pad 40 for transmitting the pressure to the wearing spacers 44 on the buffer pad 40 to make the wearing spacers 44 closer to the transparent platform 26. Therefore the sensing module 34 can be closer to the document on the transparent platform 26 and the limitation of the depth of field of the CIS is improved.

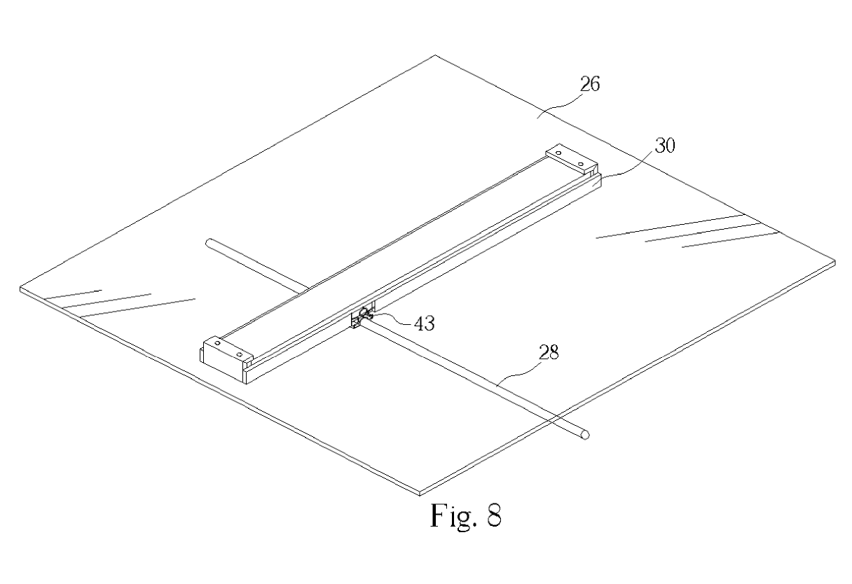

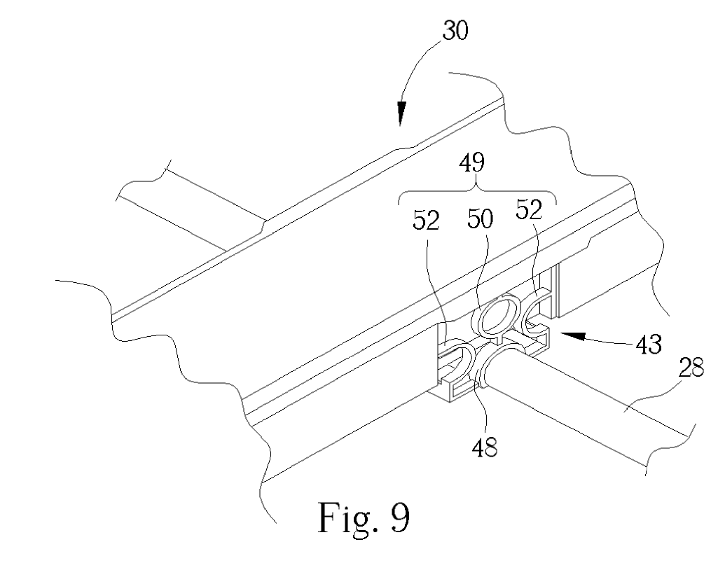

Please refer to FIG. 8 and FIG. 9. FIG. 8 is a diagram illustrating the scanning module 30 installed on the shaft 28 and FIG. 9 is an enlarged drawing of the joint of the buffer component 43 and the shaft 28. The buffer component 43 is connected to the sensor carriage 36 in union-forming structure. The buffer component 43 includes a semicircular elastic body 48 and an elastic body 49 installed above the semicircular elastic body 48 for supporting the scanning module 30 vertically. This ensures the scanning module 30 is close to the transparent platform 26, and positions the scanning module 30 on the shaft 28 aligned with the semicircular elastic body 48. The elastic body includes a circular elastic body 50 and two arched elastic bodies 52. The semicircular elastic body 48 on the bottom of the buffer component 43 is connected to the shaft 28 and supports the scanning module 30 vertically aligned with the circular elastic body 50. This provides the proper elastic force to make the scanning module 30 more closely contact with the transparent platform 26 and to stabilize the distance between the scanning module 30 and the document on the transparent platform 26. The two arched elastic bodies 52 provide the lateral elastic force to the shaft 28 to maintain the position of the scanning module 30 installed on the shaft 28 and to avoid swaying. The structure of the buffer component 43 provides the precise location of the scanning module 30 between the shaft 28 and the transparent platform 26. The buffer component 43 can be made of a spring, a fragment, or any elastic material.

In contrast to the prior art, the scanner according to the present invention provides the buffer pad 40 installed on the sensor carriage 36 for precisely positioning the scanning module 34 in the sensor carriage 36. The elastic component 42 installed on the bottom of the base 38 supports the sensing module 34 vertically and elastically ensures the scanning module 34 is close to the buffer pad 40 for transmitting the force to the wearing spacers 44 on the buffer pad 40. This makes the wearing spacers 44 closer to the transparent platform 26 so as to improve the limitation of the depth of field of the CIS and improve the scanning image quality. Another benefit of the buffer pad 40 is to hold the distance between the scanning module 30 and the document on the transparent platform 26 steady to achieve the precise location and better image quality.

Those skilled in the art will readily observe that numerous modifications and alterations of the device may be made while retaining the teachings of the invention. Accordingly, the above disclosure should be construed as limited only by the metes and bounds of the appended claims.

1. A scanner comprising:
a housing;
a transparent platform installed on the housing;
a shaft installed inside the housing; and
a scanning module installed inside the housing and on the shaft in a movable manner comprising:
a sensing module for scanning a document on the transparent platform and transforming it into a digital signal; and
a sensor carriage comprising:
a base for carrying the sensing module; and
a buffer pad connected to the base in a rotatable manner for contacting the transparent platform and fixing the sensing module in the sensor carriage.

2. The scanner of claim 1, further comprising a buffer component installed under the scanning module and connected to the shaft in a movable manner for elastically supporting the scanning module and ensuring the scanning module is close to the transparent platform.

3. The scanner of claim 1, wherein the buffer component is a spring mechanism.

4. The scanner of claim 1, wherein the sensor carriage further comprises an elastic component installed on the bottom of the base for vertically supporting the sensing module.

5. The scanner of claim 4, wherein the elastic component is a fragment.

6. The scanner of claim 4, wherein the elastic component is a spring.

7. The scanner of claim 1, further comprising at least one wearing spacer installed on the buffer pad for contacting the transparent platform.

8. The scanner of claim 7, wherein the wearing spacer is a flange of wear-resisting material.

9. The scanner of claim 1, wherein the sensing module comprises a contact image sensor (CIS), a plurality of charge coupled devices, or a plurality of complementary metal-oxide semiconductors.

10. A scanner comprising:
a housing;
a transparent platform installed on the housing;
a shaft installed inside the housing; and
a scanning module installed inside the housing and on the shaft in a movable manner for scanning a document on the transparent platform; and
a buffer component connected to the scanning module in union-forming structure and connected to the shaft in a movable manner for elastically supporting the scanning module and ensuring the scanning module is close to the transparent platform.

11. The scanner of claim 10, further comprising a sensing module for scanning a document on the transparent platform and transforming it into a digital signal, and a sensor carriage comprising a base for carrying the sensing module and a buffer pad connected to the base in a rotatable manner for contacting the transparent platform and fixing the sensing module in the sensor carriage.

12. The scanner of claim 11, further comprising at least one wearing spacer installed on the buffer pad for contacting the transparent platform.

13. The scanner of claim 12, wherein the wearing spacer is a flange of wear-resisting material.

14. The scanner of claim 11, wherein the sensor carriage further comprises an elastic component installed on the bottom of the base for vertically supporting the sensing module.

15. The scanner of claim 14, wherein the elastic component is a fragment.

16. The scanner of claim 14, wherein the elastic component is a spring.

17. The scanner of claim 11, wherein the sensing module comprises a contact image sensor (CIS).

18. The scanner of claim 10, wherein the buffer component is a spring mechanism.

19. The scanner of claim 10, wherein the buffer component comprises:
a semicircular elastic body for connecting with the shaft;
an elastic body installed above the semicircular elastic body for supporting the scanning module upwardly, making the scanning module close to the transparent platform, and positioning the scanning module on the shaft aligned with the semicircular elastic body.

20. The scanner of claim 19, wherein the elastic body comprises:
a circular elastic body installed above the semicircular elastic body for vertically supporting the scanning module and ensuring the scanning module is close to the transparent platform aligned with the semicircular elastic body; and
two arched elastic bodies for positioning the scanning module on the shaft.
